(19) United States
(12) Patent Application Publication
(10) Pub. No.: US 2006/0238798 A1
(43) Pub. Date: Oct. 26, 2006

(54) Output locations

(76) Inventors: Greg K. Justice, Vancouver, WA (US); Bruce G. Johnson, Vancouver, WA (US); Alexander C. Charney-Cohen, Vancouver, WA (US); John A. Underwood, Vancouver, WA (US); John J. Ignoffo JR., Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/111,032

(22) Filed: Apr. 21, 2005

(51) Int. Cl. G06F 3/12

(52) U.S. Cl. 358/1.15; 358/402

(57) ABSTRACT

Example embodiments of output locations are illustrated and described.

### BACKGROUND

Multifunction imaging devices may receive input from various users through various inputs and of various types. As such, when a user arrives at a device to collect printed output, the user may experience difficulty finding the printed output as the printed output sought by the user may be mixed in with other printed output.

### BRIEF DESCRIPTION OF THE DRAWINGS

FIG. 1 illustrates an imaging device according to an example embodiment.

FIG. 2 illustrates an elevator according to another example embodiment.

FIG. 3 illustrates an imaging device according to another example embodiment.

FIG. 4 is a flowchart illustrating a method according to another example embodiment.

FIG. 5 is a flowchart illustrating a method according to another example embodiment.

### DETAILED DESCRIPTION

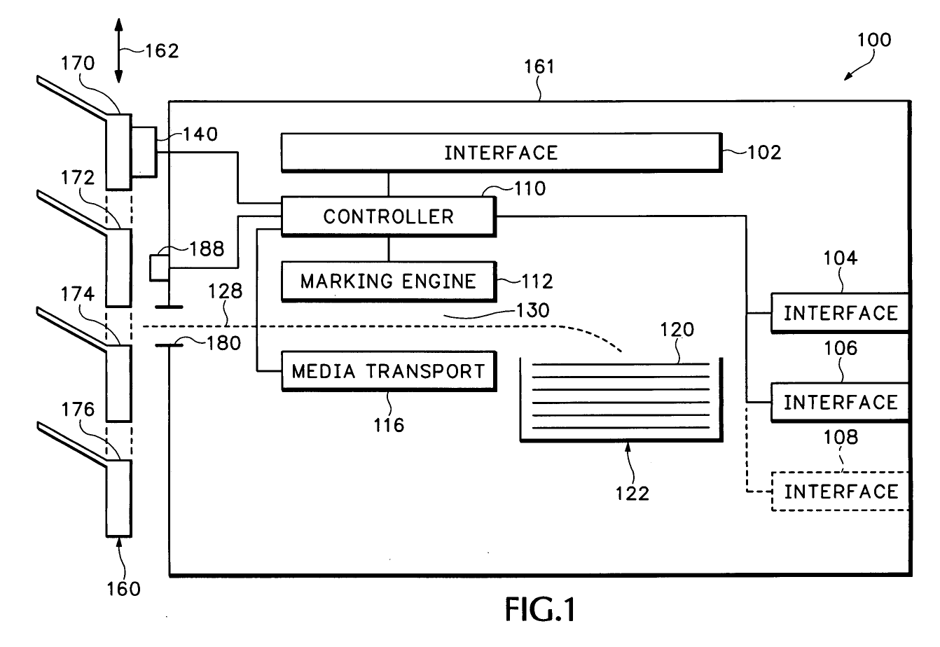

FIG. 1 illustrates an imaging device 100 according to an example embodiment. In some embodiments, the output of the device 100 is arranged, or configured, to mirror the input. That is, the device 100, in some embodiments outputs media in a manner such that printed output is routed according to the manner in which the print job input was received by the device 100 or the type of print job input.

As shown, the imaging device 100 includes interfaces 102, 104, 106. An optional interface 168 is also illustrated. Print jobs, or data to be printed, may be received at the imaging device 100 via one or more of the interfaces 102-108. The interfaces 102-108 may, for example, comprise a scanner, a port, a network card, modem, a memory reader, or other suitable interface for receiving data to be printed. In some embodiments, the interface 102 comprises a scanner for receiving copy print jobs at or near a top of the device 100.

A controller 110 is coupled to the interfaces 102-108 and receives data relating to print jobs from the interfaces 102-108. In some embodiments, the controller 110 may be referred to as a “formatter.” According to some embodiments, the controller 110 generally comprises a processing unit in communication with one or more of the interfaces 102-108, marking engine 112, media transport 116, and actuator 140.

For purposes of this disclosure, the term “processing unit” shall mean a conventionally known or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 110 is not limited to any specific combination of hardware circuitry and software, nor to any particular source for the instructions executed by the processing unit.

The controller 110 is also configured to generate control signals for controlling the marking engine 112 to at least partially form one or more images on media 120 as the media transport 116 advances the media 120 from a media input location 122 along media path 128. The marking engine 112 may comprise, for example, an inkjet marking engine, an electrostatic marking engine, or other suitable marking engine. In embodiments where the marking engine 112 comprises an inkjet marking engine, the marking engine 112 may comprise a single printhead or multiple printheads. The printheads may be stationary or may move during printing and servicing operations.

The controller 110 is also configured to generate control signals for controlling the media transport 116. The media transport 116 may comprise one or more belts, rollers, drums or other suitable media handling device(s) for advancing media 120 from the media input 122 along the path 128. The media transport 116 advances media 120 through a print zone 130 near the marking engine 112. The media 120 may be at least partially imaged by the marking engine 112 at the print zone 130.

The controller 110 is also configured to generate control signals for controlling an actuator 140. The actuator 140 is a linear actuator for causing an elevator 160 to move vertically in directions 162. The elevator 162 has output locations 170, 172, 174, 176. The controller 110 controls positioning of the elevator 160 to align one of the output locations 170-176 with opening 180. The actuator 110 may also be configured to cause the elevator 160 to move horizontally in directions into and out of the page.

In some embodiments, the controller 110 selects a position for the elevator 160 based on the one of the interfaces 102-108 through which the data to be printed was received. For example, in one embodiment, the controller 110 is configured to select output location 170 for print jobs received via interface 102, select output location 172 for print jobs received via interface 104, select output location 174 for print jobs received via interface 106, and select output location 176 for sheets of waste media. Hence, according to this example, if the device 100 received a print job, such as a print job from a network personal computer, via interface 106, the controller 110 would select the output location 174 for this print job. If the output location 174 is not aligned with the opening 180, the controller 110 sends signals to actuator 140 to move the elevator 160 in one of the directions 162 to substantially align the output location 174 with the opening 180 so that the media 120 would advance along the path 128 to the output location 174. Similarly, if the device 100 received a print job, such as a copy print job, from interface 102, configured as a scanner, the controller 110 would select the output location 170. If the output location 170 is not aligned with the opening 180, the controller 110 sends signals to the actuator 140 to move the elevator 160 in one of the directions 162 to substantially align the output location 170 with the opening 180 so that the media 120 would advance along the path 128 to the output location 174.

As such, it can be seen that, in some embodiments, the controller 110 is configured to select an output location for a print job using the interface via which the device 100 receives the print job. Consequently, users seeking to collect printed media sent to the device 100 at a particular interface may collect the printed media at an output location associated with that interface.

In other embodiments, the controller 110 selects a position for the elevator 160 based on the type of data to be printed. For example, types of data to be printed may include copy print jobs, facsimile print jobs, network print jobs from a personal computer, and waste media. In these embodiments, the controller 110 may be configured to select output location 170 for copy print jobs, select output location 172 for facsimile print jobs, output location 174 for network print jobs, and output location 176 for waste media. In some implementations, the waste media may comprise media pages not verified as complete at the time of a print stoppage event, such as a power failure, media jam, or opening of a device door (not shown).

Hence, according to this example, if the device 100 received a print job, such as a print job from a network personal computer, regardless of the interface through which the print job was received, the controller 110 would select the output location 174 for this print job. If the output location 174 is not aligned with the opening 180, the controller 110 sends signals to actuator 140 to move the elevator 160 in one of the directions 162 to substantially align the output location 174 with the opening 180 so that the media 120 would advance along the path 128 to the output location 174. Similarly, if the device 100 received a copy print job the controller 110 would select the output location 170. If the output location 170 is not aligned with the opening 180, the controller 110 sends signals to the actuator 140 to move the elevator 160 in one of the directions 162 to substantially align the output location 170 with the opening 180 so that the media 120 would advance along the path 128 to the output location 174.

The actuator 140 is a linear actuator configured to move the elevator 160 in directions 162 according to signals received from the controller 110. The actuator 140 may comprise any of a variety of actuators suitable for raising and lowering the elevator 160 relative to the housing 161 of the device 100. In one embodiment, the actuator 140 includes a motor with a worm gear coupled, via one or more gears, to a rack attached to one of the housing 161 and elevator 160. As the controller 110 drives the motor in different directions, the elevator 160 moves up and down. Of course, the output locations 170-176 may be vertically moved using other suitable devices, including one or more belts, solenoids, gears, transmissions, or the like. Position sensor 188 may be coupled to the controller 110 for providing information to the controller regarding the current position of the elevator 160.

In other embodiments, the output locations are stationary and the position of the opening 180 is varied based on the output location selected by the controller 110.

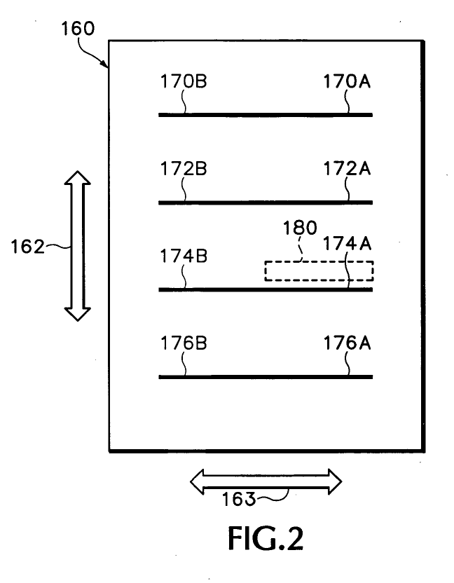

FIG. 2 illustrates a simplified view of an example embodiment of the elevator 160 (FIG. 1). In the embodiment shown in FIG. 2, the elevator 160 includes output locations 170A, 170B, 172A, 172B, 174A, 174B, 176A, and 176B. The elevator 160 is movable vertically in directions 162 and is also movable horizontally in directions 163. The controller 110 is configured to send control signals to move the elevator 160 to control the vertical and horizontal movements of the elevator 160 with respect to the housing 161 (FIG. 1).

As such, pursuant to this embodiment, by moving the elevator 160 vertically, and horizontally, the controller 160 can select any of output locations 170A, 170B, 172A, 172B, 174A, 174B, 176A, and 176B and cause any of these output locations to be aligned with opening 180 (shown in dotted lines in FIG. 2). As shown in FIG. 2, the output locations 170A and 170B may comprise adjacent portions of a common surface, the output locations 172A and 172B may comprise adjacent portions of a common surface, the output locations 174A and 174B may comprise adjacent portions of a common surface, and output locations 176A, and 176B may comprise adjacent potions of a common surface. Thus, by moving the elevator 160 in directions 163, the controller 110 (FIG. 1) may select any of the output locations 170A, 170B, 172A, 172B, 174A, 174B, 176A, and 176B based at least in part on the interface through which the print job was received, the type of print job, or both.

In some embodiments, the controller 110 disposes sequential print jobs of a common type or received via a common interface in adjacent locations by causing the elevator 160 to move horizontally in one of directions 163. For example, the controller 110 may be configured to select adjacent locations 170A and 170B for sequential print jobs received via interface 102. As another example, the controller 110 may be configured to select adjacent locations 172A and 172B for sequential print jobs of the same type, such as sequential network print jobs.

In still other embodiments, the controller 110 may be configured to select adjacent one of the output locations 170A, 170B, 172A, 172B, 174A, 174B, 176A, and 176B based on the interface through which a particular print job is received. For example, the controller 110 may be configured to select output location 172A for print jobs received via interface 106 (FIG. 1) and to select and to select output location 172B for print jobs received via interface 108 (FIG. 1).

In yet other embodiments, the controller 110 may be configured to select adjacent one of the output locations 170A, 170B, 172A, 172B, 174A, 174B, 176A, and 176B based on the type of print job received. For example, the controller 110 may be configured to select output location 172A for facsimile print jobs and to select and to select output location 172B for copy print jobs.

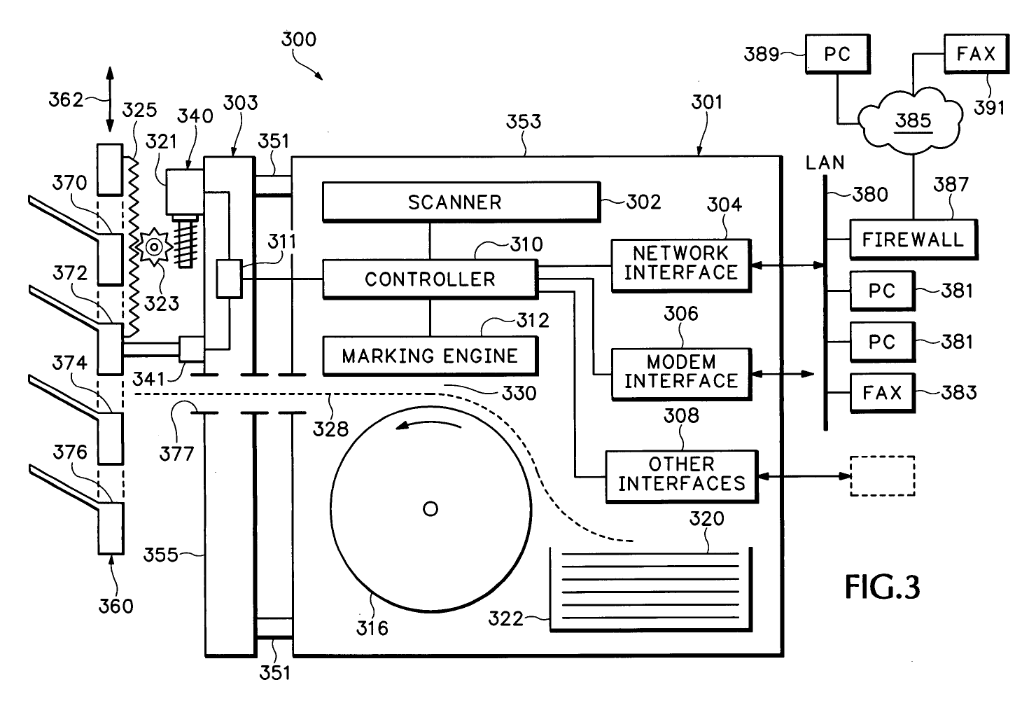

FIG.3 illustrates an imaging device 300 in accordance with another example embodiment. The device 300 generally includes unit 301 and finisher 303. The unit 301 is generally configured to receive print jobs via one or more of a scanner 302, network interface 304, modem interface 306, and other interfaces 308. A drum platen 316 is configured to advance a medium 320 from an input location 322 through a print zone 330 along a path 328. A marking engine 312 at least partially forms an image or deposits a fluid on the medium 320 when the medium 320 is in the print zone 330.

As shown in FIG. 3, the network interface 304 is configured to be coupled to a local area network (LAN) 380 and may receive print jobs from network personal computers 381, network facsimile machines 383, or other suitable network device. The other interfaces 308 may comprise, for example, one or more of a USB interface, a memory card reader, a Bluetooth interface, an infrared interface, or other suitable device for receiving print job data.

The network interface 304 may comprise, in some embodiments, a wireless interface, such as an interface compliant with IEEE 802.11b. In other embodiments, the network interface 304 may include a port or network card for connecting with a wired network. Further, the local area network 380 may be coupled to one or more other networks 385, such as the Internet, via a firewall 387 or other suitable device. In this configuration, the imaging device 300 may receive print jobs from personal computers 389 or facsimile machines 391 over networks 385, 380 via the network interface 304.

A controller 310 is coupled to the scanner 302, the network interface 304, the modem interface 306, and the other interfaces 308 and is configured to receive print job data from these interfaces. The controller 310 is also coupled to and controls the marking engine 310 to cause the marking engine 310 to at least partially image or deposit fluid on the medium 320 according to print job data received via one or more of the interfaces. Further, the controller 310 also controls movement of the drum platen 316.

The finisher 303 is removably coupled to the unit 301 via one or more connectors 351. The connectors 351 connect a housing 353 of the unit 301 with a housing 355 of the finisher 355 to limit or prevent significant relative movement between the housings 353, 355. One or more connectors 359 couple the controller 310 of the unit 301 with a controller 311 of the finisher 303. The controller 310, in this configuration, may exchange data signals with the controller 311 of the finisher 303 via the one or more connectors 359.

The controller 311 of the finisher 303 is configured to receive data signals from the controller 310 and to move and elevator 360 in response to the data signals received from the controller 310. The data signals sent from the controller 310 to the controller 311 may comprise, for example, identification of an output location for a print job.

The controller 311 of the finisher 303 is also configured to control operation of vertical actuator 340 and horizontal actuator 341. The vertical actuator 340 functions to move elevator 360 in directions 362 to align one of the output locations 370, 372, 374, 367 with the opening 377 of the finisher 303 to permit a medium exiting the opening 377 to be deposited at a selected one of the output locations. The horizontal actuator 341 is configured to move the elevator 360 horizontally relative to the housing 335 of the finisher 303. The horizontal movement of the elevator 360 is generally in a direction orthogonal to directions 362 and, with reference to FIG. 3, is in the directions into and out of the page.

The vertical actuator 340, according to an example embodiment, comprises a motor 321 with a worm gear at an output shaft thereof for driving one or more gears 323 engaged with a rack 325. The motor 321 may comprise a DC motor in some embodiments. The rack 325, in this example embodiment, is mounted on the elevator 362 and permits the elevator 360 to be raised and lowered by changing the direction of rotation of the motor 321. The vertical actuator 340 comprises an example mechanism for directing output media to a selected output location. Other suitable mechanisms for directing output media to a selected output location may alternatively be employed. In this regard, U.S. Pat. Nos. 5,551,686; 6,456,386; 5,898,592; 5,328,169 are each hereby incorporated by reference in their respective entireties.

The horizontal actuator 340, according to an example embodiment, may include a motor and any of a variety of lateral offset mechanisms configured to move the elevator 360 in directions into and out of the page (FIG. 3) and orthogonal to directions 362. Thus, the horizontal actuator 340 permits offset sorting. Other suitable mechanisms and devices for performing offset sorting by laterally, or horizontally, moving an output location relative to a finishing device may alternatively be employed. In this regard, in addition to the U.S. patents listed above, U.S. Pat. No. 6,250,631 is also hereby incorporated by reference.

In operation, the device 300 receives a print job via one of the scanner 302, network interface 304, modem interface 306, or other interfaces 308. The controller 310, in some embodiments, may then select one of the output locations 370-376 based at least in part on the one of the interfaces, 302, 304, 306, 308 through which the device 300 receives a print job. For example, in one embodiment, the controller 310 is configured to select output location 370 for print jobs received via scanner 302, select output location 372 for print jobs received via network interface 304, select output location 374 for print jobs received via modem interface 306. The controller 310 may be further configured to select output location 376 for sheets of waste media, print jobs received via any other interface 308, or both.

The controller 310 may be user-configured to specify these associations between the interfaces 302-308 and the respective output locations 370-376. In one embodiment, the controller 310 may be configured remotely, such as by using device configuration software at one of the network personal computers 381. As such, the selection of which output location is associated with print jobs received from which interface may be varied by the user, such as a system administrator.

In other embodiments, the controller 310 is configured to select one of the output locations 370-376 based at least in part on the type of print job received by the controller 310. For example, the controller 310 may be configured to select output location 370 for copy print jobs, output location 372 for network print jobs, output location 374 for facsimile print jobs, and output location 376 for waste media. Thus, in these embodiments, the controller 310 determines a type of print job and then selects an output location based on or using the type of print job. Print job types may include, but are not limited to the following example types, copy, network print job, facsimile, and the like.

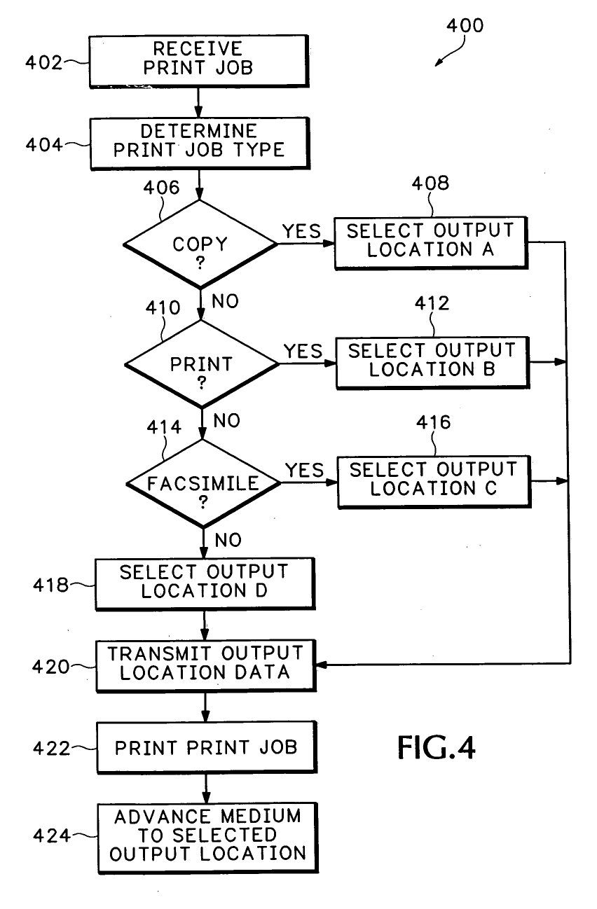

FIG. 4 is a flowchart of an example method 400. At block 402, a print job is received. The print job may be received at an interface of a device, such as via a scanner, port, network card, or other suitable interface. Execution then proceeds to block 404. At block 404, the type of print job is determined. In some embodiments, a controller or formatter, such as one of the controllers 110 (FIG. 1), 310 (FIG. 3) may perform the determination of print job type. Execution then proceeds to block 406. At block 406, it is determined whether the print job is a copy type print job. If determination at block 406 is “yes” then execution proceeds to block 408 and output location A is selected, else execution proceeds to block 410. In some embodiments, the determination of block 406 may be performed by a suitable controller or formatter, such as one of the controllers 110, 310. Output location A may comprise, for example one of the output locations shown in FIGS. 1-3.

At block 410, it is determined whether the print job is a print type print job. If determination at block 410 is “yes” then execution proceeds to block 412 and output location B is selected, else execution proceeds to block 414. In some embodiments, the determination of block 410 may be performed by a suitable controller or formatter, such as one of the controllers 110, 310. Output location B may comprise, for example one of the output locations shown in FIGS. 1-3 that differs from the output location A.

At block 414 it is determined whether the print job is a facsimile type print job. If determination at block 414 is “yes” then execution proceeds to block 416 and output location C is selected, else execution proceeds to block 418. In some embodiments, the determination of block 414 may be performed by a suitable controller or formatter, such as one of the controllers 110, 310. Output location C may comprise, for example one of the output locations shown in FIGS. 1-3 that differs from the output locations A and B.

At block 418 output location D is selected and then execution proceeds to block 420. Output location D may comprise, for example one of the output locations shown in FIGS. 1-3 that differs from the output locations A, B, and C.

At block 420, output location data that specifies or identifies the selected output location is transmitted. In embodiments in which a finisher, such as the finisher 360 (FIG. 3), is employed, a controller, such as the controller 310 (FIG. 3), transmits the output location data to a finisher controller, such as the finisher controller 311 (FIG. 3). In some embodiments, the finisher controller is configured to receive the output location data and to position an elevator or sorter using or based on the output location data.

Further, it should be noted that in some embodiments, block 420 may be omitted. In these embodiments, the same controller that selects the output location controls the elevator or sorter to position the elevator or sorter using output location data.

At block 422, the print job is printed. In some embodiments, the print job is printed by at least partially forming an image on a medium using a suitable marking engine.

At block 424, the medium is advanced to the selected output location. The manner in which the medium is advanced to the selected output location may comprise moving the output location based on the output location data. In other embodiments, the manner in which the medium is advanced to the selected output location may comprise routing the media to a selected one of multiple stationary output locations. The output locations may comprise different bins, trays or the like. In some embodiments, the output locations may comprise different locations, or portions, of a single bin or tray.

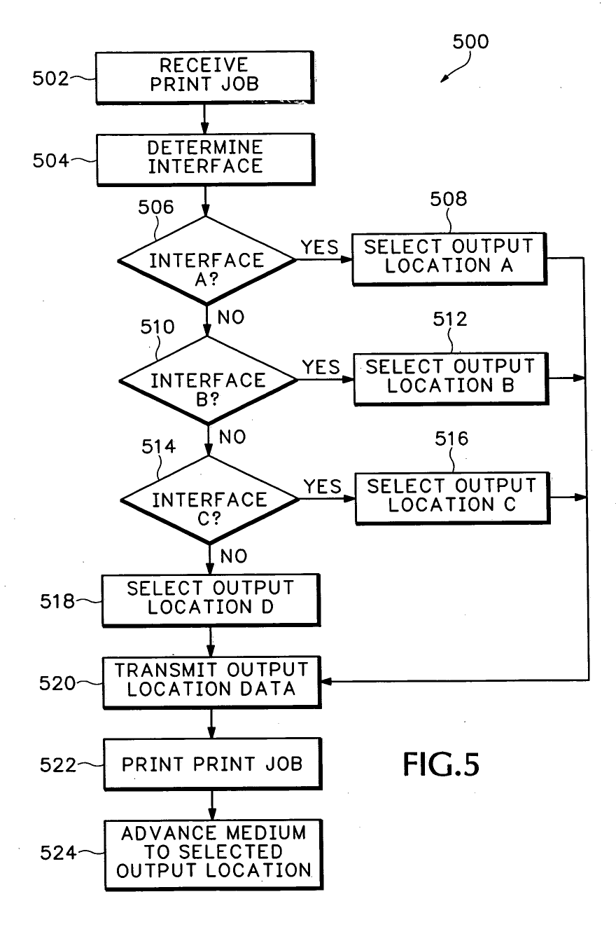

FIG. 5 is a flowchart of an example method 500. At block 502, a print job is received. The print job may be received at an interface of a device, such as via a scanner, port, network card, or other suitable interface. Execution then proceeds to block 504. At block 504, the interface through which the print job was received is determined. In some embodiments, a controller or formatter, such as one of the controllers 110 (FIG. 1), 310 (FIG. 3) may perform the determination of the interface through which the print job was received. Execution then proceeds to block 506. At block 506, it is determined whether the print job was received at interface A. Interface A may comprise one of the interfaces of an imaging device. If determination at block 506 is “yes” then execution proceeds to block 508 and output location A is selected, else execution proceeds to block 510. In some embodiments, the determination of block 506 may be performed by a suitable controller or formatter, such as one of the controllers 110, 310. Output location A may comprise, for example one of the output locations shown in FIGS. 1-3.

At block 510, it is determined whether the print job was received at interface B. If determination at block 510 is “yes” then execution-proceeds to block 512 and output location B is selected, else execution proceeds to block 514. In some embodiments, the determination of block 510 may be performed by a suitable controller or formatter, such as one of the controllers 110, 310. Output location B may comprise, for example one of the output locations shown in FIGS. 1-3 that differs from the output location A.

At block 514 it is determined whether the print job was received at interface C. If determination at block 514 is “yes” then execution proceeds to block 516 and output location C is selected, else execution proceeds to block 518. In some embodiments, the determination of block 514 may be performed by a suitable controller or formatter, such as one of the controllers 110, 310. Output location C may comprise, for example one of the output locations shown in FIGS. 1-3 that differs from the output locations A and B.

At block 518 output location D is selected and then execution proceeds to block 520. Output location D may comprise, for example one of the output locations shown in FIGS. 1-3 that differs from the output locations A, B, and C.

At block 520, output location data that specifies or identifies the selected output location is transmitted. In embodiments in which a finisher, such as the finisher 360 (FIG. 3), is employed, a controller, such as the controller 310 (FIG. 3), transmits the output location data to a finisher controller, such as the finisher controller 311 (FIG. 3). In some embodiments, the finisher controller is configured to receive the output location data and to position an elevator or sorter using or based on the output location data.

Further, it should be noted that in some embodiments, block 520 may be omitted. In these embodiments, the same controller that selects the output location controls the elevator or sorter to position the elevator or sorter using output location data.

At block 522, the print job is printed. In some embodiments, the print job is printed by at least partially forming an image on a medium using a suitable marking engine. At block 524, the medium is advanced to the selected output location. The manner in which the medium is advanced to the selected output location may comprise moving the output location based on the output location data. In other embodiments, the manner in which the medium is advanced to the selected output location may comprise routing the media to a selected one of multiple stationary output locations. The output locations may comprise different bins, trays or the like. In some embodiments, the output locations may comprise different locations, or portions, of a single bin or tray.

The sequence of the various blocks shown in FIGS. 4 and 5 may be altered in some embodiments. Further, in other embodiments, one or more of the blocks of FIGS. 4 and 5 may be omitted.

Although the foregoing has been described with reference to example embodiments, workers skilled in the art will recognize that changes may be made in form and detail without departing from the scope of thereof. For example, although different example embodiments may have been described as including one or more features providing one or more benefits, it is contemplated that the described features may be interchanged with one another or alternatively be combined with one another in the described example embodiments or in other alternative embodiments. Unless specifically otherwise noted, the claims reciting a single particular element also encompass a plurality of such particular elements.

What is claimed is:

1. A method, comprising:
receiving print job input from one of multiple device interfaces;
selecting one of multiple output locations based at least in part on the device interface from which the input was received, the output locations configured to receive media.

2. The method of claim 1, wherein the multiple device interfaces include a network interface and a scanner.

3. The method of claim 1, further comprising:
printing at least a portion of the input on a medium;
advancing the medium to the selected one of the multiple output locations.

4. The method of claim 1, further comprising moving the multiple output locations based on the device interface from which the input was received.

5. The method of claim 1, further comprising advancing a medium to the selected one of the multiple output locations.

6. A method, comprising:
receiving a print job of one of multiple types;
selecting one of multiple output locations based at least in part on the type of print job.

7. The method of claim 6, wherein the multiple types include facsimile and network print job.

8. The method of claim 6, wherein the multiple types include copy and network print job.

9. The method of claim 6, wherein the multiple types include copy, facsimile, and network print job.

10. The method of claim 6, further comprising:
printing at least a portion of the print job on a print medium;
advancing the print medium to the selected output location.

11. The method of claim 6, wherein the output locations comprise vertically-arranged trays.

12. The method of claim 11, wherein the advancing further comprises moving the trays.

13. The method of claim 6, further comprising:
determining that the print job is a copy type of print job;
advancing a medium to one of the output locations associated with a copy type of print job.

14. A device, comprising:
output locations, each output location associated with a type of input;
a print engine for at least partially printing on media according to the type of input;
a mechanism configured to deposit the media at the output location associated with the type of input.

15. The device of claim 14, wherein the types of input comprise copy input, facsimile input, network print job input.

16. The device of claim 14, further comprising a system for moving the output locations vertically to permit deposits at different ones of the output locations.

17. The device of claim 14, further comprising a system for moving the output locations horizontally to offset successive deposits into a selected one of the output locations.

18. The device of claim 14, further comprising a controller configured to determine the type of input and to cause the device to deposit the media at the output location associated with the type of input.

19. A device, comprising:
means for detecting one of different input types;
means for advancing media into one of multiple output locations based on the detected input type.

20. The device of claim 19, wherein the input types comprise facsimile, copy, and network print job.

21. A computer readable medium comprising instructions for instructing a device to perform the following:
determining an interface through which a print job is received;
selecting an output location based at least in part on the determined interface.

22. The computer readable medium of claim 21, wherein the instructions further comprise advancing a medium to the selected output location.

23. A method, comprising:
receiving a first print job at a first interface;
printing at least a portion of the first print job on a first medium;
advancing the first medium to a first output location associated with the first interface;
receiving a second print job at a second interface;
printing at least portion of the second print job on a second medium;
advancing the second medium to a second output location, the second output location being associated with the first interface and different from the first output location.

24. The method of claim 23, further comprising:
identifying the interface through which the first print job was received;
selecting the first output location based at least in part on the identified interface.

25. The method of claim 23, wherein the first and second output locations are adjacent portions of a common surface.

26. The method of claim 23, wherein the first interface is a scanner and the second interface is configured to receive data from a network.

27. The method of claim 24, wherein the advancing the first medium further comprises moving the first output location vertically.
